(19) United States
(12) Patent Application Publication
(10) Pub. No.: US 2011/0070764 A1
(43) Pub. Date: Mar. 24, 2011

(54) LOCKING CAP FOR A CONNECTOR-FASTENING SCREW

(76) Inventor: Takuro Miya, Kanagawa (JP)

(21) Appl. No.: 12/994,546

(22) PCT Filed: Apr. 9, 2009
(86) PCT No.: PCT/US2009/040054

§ 371 Date: Nov. 24, 2010

(30) Foreign Application Priority Data
May 30, 2008 (JP) 2008-143216

(51) Int. Cl. H01R 13/627

(52) U.S. Cl. 439/359

(57) ABSTRACT

Provided are means for locking a fastening screw of a connector, such as a locking cap for a connector-fastening screw that comprises a main body having a receiving hole, a contact part of the main body for control of rotation of the main body, and an indicator part of the main body for making possible visual recognition of rotation of the main body.

### FIELD

The present invention relates to locking of a connector and more specifically relates to locking of a screw for fastening a connector.

### BACKGROUND

Many connectors capable of readily attaching a cable to equipment, or removing a cable from equipment, are used for connection of electrical cables, fiber optic cables, and the like to electronic equipment. Among such connectors are connectors that fasten together with a mating member by use of a screw for reliable maintenance of the state of joining together with the equipment. A structure that uses a screw for fastening has the advantage of increased joining-together strength in comparison to other means, such as a structure utilizing a locking piece capable of elastic deformation and constructed from plastic and the like. However, there is a chance of the screw becoming loose due to vibration and the like occurring in the environment of use of the connector such that the connector falls out.

Various types of attempts have been made to prevent a connector fastened by a fastening screw from falling out due to vibration or shock. For example, Patent Citation No. 1 (U.S. Pat. No. 7,033,202) mentions “a cable end connector includes an insulating housing with a number of contacts retained therein, a first cover receiving the insulating housing therein, a second cover assembled to the first cover, a pair of fastening members, and a pair of spring members.” According to the connector mentioned in this citation, “if the screw connection between the cable end connector and the complementary connector becomes loosened due to vibration/physical shock during use, the spring member automatically resumes to its original shape to motivate the fastening member to move rearwardly until the stop section abuts against the rear ends of the recessed sections. Thus, the loose connection between the cable end connector and the complementary connector can be easily detected, whereby the user can immediately secure the cable end connector with the complementary connector to ensure a reliable connection therebetween.”

### SUMMARY

For all connectors, without regard as to whether or not there is concern for vibration in the environment of use of the connector, to contain a locking means for a fastening screw is disadvantageous from the standpoints of cost and the like, and there is concern that size of the resultant connector would become excessively large. Moreover, determination of the need for the locking means beforehand is often difficult. Furthermore, when a locking means becomes needed (due to reasons such as change of installation location of the equipment and the like) for a connector connected to equipment, there is a need to replace the existing connector with a connector equipped with a locking means. Also, when there is a need for this locking means to respond in some type of deformational or mechanical manner to the mating member, application of a connector equipped with a locking means to existing equipment becomes more difficult.

Moreover, even when a locking means has been provided, there may be the possibility of occurrence of looseness of the fastening screw by the imparting of vibration and the like that is greater than anticipated. In such cases when looseness of the fastening screw can not be ascertained from the exterior, looseness of the fastening screw may not be detected until the connector falls out and the electrical connection is interrupted.

Thus according to one aspect of the present invention, a locking cap for a connector-fastening screw is provided that comprises: a main body having a receiving hole, a contact part disposed on the main body for control of rotation of the main body, and an indicator part disposed on the main body capable of providing visual recognition of rotation of the main body.

According to an aspect of the present invention, the locking cap is capable of being appended to the fastening screw of the connector. Thus the occurrence of looseness of the fastening screw can be made visible due to rotation of the position of the indicator part due to looseness of the fastening screw.

A locking cap according to one embodiment of the present invention is affixed to a handling part of a fastening screw provided on an electrical connector, fiber optic connector, and the like which is fixed to another connector by the fastening screw. A receiving hole is provided in the locking cap for receiving the handling part, the inner face of the locking cap engages with the outer peripheral face of the handling part, and the locking cap is capable of rotation in a unified manner with the fastening screw. The locking cap has a contact part, and at a certain time as the fastening screw loosens and rotates together with the locking cap in a unified manner, the contact part contacts the connector, and further rotation is suppressed. It becomes possible by this means to prevent loosening of the fastening screw. Moreover, since the indicator part of the locking cap also rotates due to rotation of the fastening screw, detection of the occurrence of looseness of the fastening screw is possible even when loosening of the fastening screw itself is not visible.

### BRIEF DESCRIPTION OF THE DRAWINGS

FIG. 1 is a perspective drawing showing the first embodiment of the present invention.

FIG. 2 is a partial planar cross-sectional diagram showing condition of use of the first embodiment of the present invention.

FIG. 3a is a front view of the locking cap mounted on the connector, according to the first embodiment of the present invention.

FIG. 3b is a front view of the locking cap in contact with the connector, according to the first embodiment of the present invention.

FIG. 4 is a perspective drawing showing the second embodiment of the present invention.

FIG. 5a is a planar drawing of the locking cap, according to the third embodiment of the present invention.

FIG. 5b is a planar drawing of the locking cap, according to a variant example of the third embodiment of the present invention.

FIG. 5c is a planar drawing of the locking cap, according to another variant example of the third embodiment of the present invention.

FIG. 5d is a planar drawing of the locking cap, according to another variant example of the third embodiment of the present invention.

FIG. 6a is a front view showing the locking cap mounted on a connector, according to the third embodiment of the present invention.

FIG. 6b is a front view showing the locking cap in contact with a connector, according to the third embodiment of the present invention.

FIG. 7a is a perspective drawing showing a locking cap, according to the fourth embodiment of the present invention.

FIG. 7b is a perspective drawing showing a locking cap, according to the variant example of the fourth embodiment of the present invention.

### DESCRIPTION OF REFERENCE NUMBERS

1 . . . locking cap
10 . . . main body
12 . . . side face
13 . . . corner part
14 . . . front end face
16 . . . rear end face
18 . . . receiving hole
20 . . . inner face
22 . . . protrusion
24 . . . side wall
26 . . . edge part
28 . . . exterior face
30 . . . lower face
32 . . . front face
34 connection part
35a . . . first part
35b . . . second part
36 . . . ring-shaped part
40 . . . cable connector
41 . . . joining face
42 . . . housing
44, 44a . . . side face
46 . . . fastening screw
48 . . . handling part
48a . . . outer peripheral face
49 . . . screw part
50 . . . cable
54 . . . receptacle
56 . . . female screw

### DETAILED DESCRIPTION

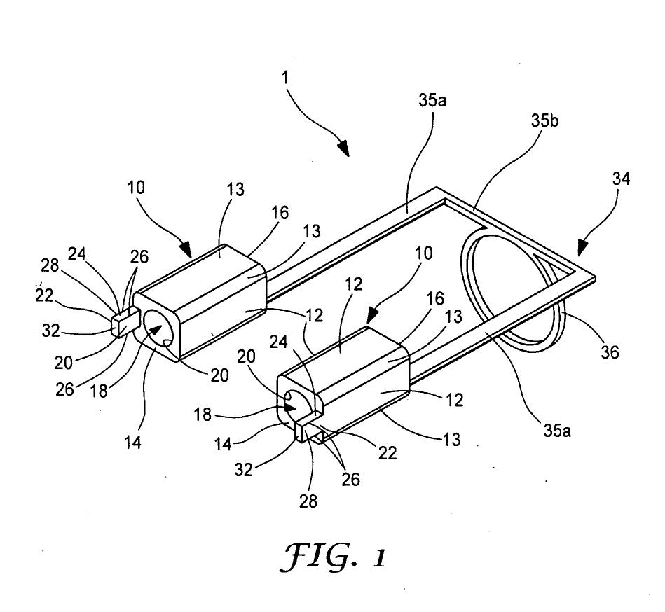

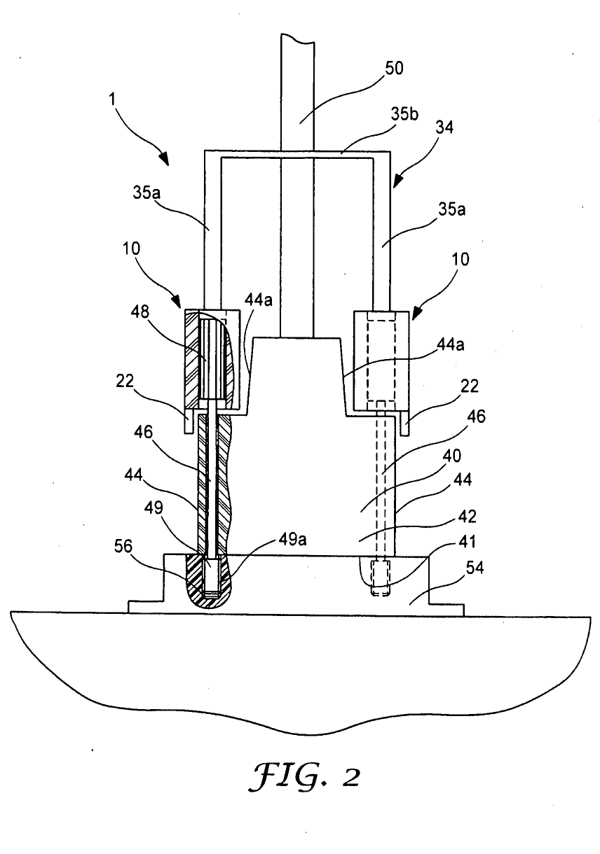

The present invention is explained below using various embodiments. FIG. 1 is a perspective view that shows a locking cap according to one embodiment of the present invention. FIG. 2 is a planar view showing the state of the locking cap of the present invention during use on a cable connector. A locking cap 1 comprises a main body 10, a protrusion 22 protruding from the main body 10, and a connection part 34 connecting together two main bodies 10, 10. The connection part 34 is made flexible enough so that the main body 10 can rotate with respect to the axial direction of the main body 10 to a degree needed as a locking cap of present invention, for example, one rotation or less. The cable connector 40 fits together with a receptacle 54 and is fastened to the receptacle 54 using a fastening screw 46. The locking cap 1 of the present invention is mounted on a handling part 48 of the fastening screw 46.

The main body 10 is an approximately rectangular body provided with a front end face 14 at one tip in the length-wise direction thereof and provided with a rear end face 16 at the opposite tip. The front end face 14 and the rear end face 16 are each roughly formed as a respective rectangle. The main body 10 is further provided with a plurality of side faces 12 which intersect with both of the front end face 14 and the rear end face 16, where the long sides of the side faces 12 are substantially aligned with the length-wise direction of the main body 10. A corner part 13 is present between adjacent side faces 12 and 12 such that the two adjacent side faces are smoothly interconnected. Size of the main body 10 can be set such that a slight gap occurs between the cable connector 40 and the main body 10 when the locking cap 1 is mounted on the cable connector 40. In this manner, rotation of the main body 10 is permitted when the fastening screw 46 is loose, and visual detection of the occurrence of looseness becomes possible. In this manner, looseness of the fastening screw 46 appears as rotational movement of the main body 10, and slight looseness of the fastening screw 46 can be readily recognized visually.

A receiving hole 18 is provided as a circular through-hole in the front end face 14 of the main body 10. The receiving hole 18 is demarcated by an inner face 20. The receiving hole 18 is disposed at the approximate center of the front end face 14, and interior diameter of the receiving hole 18 has roughly the same size as outer diameter of the handling part 48 of the fastening screw 46. The inner face 20 at least partially engages with an outer peripheral face 48a of the handling part 48 of the connector-fastening screw 46, and thus the main body 10 and the connector-fastening screw 46 become able to rotate as a single unit. Thus the inner face 20 can have a shape which is complimentary with the shape of the handling part 48. It is also possible to provide one or a plurality of protrusions on the inner face 20, or to provide one or a plurality of grooves extending in the axial direction of the main body 10, such that the handling part 48 is more securely engaged with the main body 10.

The protrusion 22 is a tabular shaped part that projects forward from the front end face 14. Protrusion 22 is provided with a wide exterior face 28 that faces outwardly, a lower face 30 disposed opposite to the exterior face 28, a pair of side walls 24 and 24 having long sides extending in the length-wise direction of the main body 10 and intersect with the exterior face 28 and the lower face 30, and a front face 32 disposed at the distal tip of the protrusion 22 and having a face which is roughly parallel with the front end face 14 and intersects with the exterior face 28, the lower face 30, and the two side walls 24 and 24. Plurality of edge parts 26 are provided between the side walls 24 and the lower face 30 of the protrusion 22, as well as between the side walls 24 and the exterior face 28. The edge part 26 is where two faces of the protrusion 22 intersects each other and forms a line. According to the present embodiment, the exterior face 28 of the protrusion 22 is flush with one side face 12 of the main body 10, and the side walls 24 and 24 and the inner face 30 are each recessed relative to their corresponding side faces 12, i.e., the sides faces facing the same direction. When the fastening screw 46 has loosened to an extent such that rotation occurs, part of the protrusion 22 contacts the cable connector 40, and the protrusion 22 is able to display a function that restricts further loosening of the fastening screw 46. The presence or absence of looseness of the fastening screw 46 can also be readily visualized by checking for change of the position of the protrusion 22 relative to the cable connector 40. Furthermore, the protrusion 22 can be formed such that the exterior face 28 is disposed to the exterior of the side face 12. Shape of the protrusion 22 is not limited to the above mentioned tabular shape, and the protrusion can be formed as a polygonal column, circular column, or hemispherical protrusion. The degree of protrusion of the protrusion 22 can be set arbitrarily as long as the degree of protrusion makes possible contact between the protrusion 22 and the cable connector 40 when the locking cap 1 is attached to the cable connector 40 and the main body 10 is rotated. Moreover, although width of the exterior face 28 was smaller than width of the side face 12 according to the present embodiment, width of the exterior face 28 can also be made the same as width of the side face 12. Although protrusion 22 is disposed such that the width-direction center of the exterior face 28 roughly coincides with the width-direction center of the side face 12, disposal is possible such that these centers do not coincide. That is to say, it is possible to dispose the protrusion 22 at a position displaced from the width-direction center of the side face 12.

The connection part 34 is a part that connects together two main bodies 10 and 10 and extends from the rear end face 16 of a first main body 10 to the rear end face 16 of the other main body 10. The connection part 34 makes possible handling of the main bodies 10 and 10 as a single unit. The connection part 34 is flexible enough to allow rotation of the main body 10. The connection part 34 is provided with first parts 35a extending from the main body 10 in the length-wise direction of the main body 10 and a second part 35b connected to the pair of first parts 35a. The first part 35a has a ribbon shape and has a length-direction cross-sectional shape that is roughly rectangular. The second part 35b has a roughly square cross-sectional shape in the length-wise direction thereof. The connection part 34 can have an arbitrary shape that differs from the illustrated ribbon shape. The connection part 34, rather than extending from the rear end face 16 of the main body 10, can also extend from one of the side faces 12 of the main body 10. The connection part 34 may be provided by integration with the main body 10 or can be provided as a separate component.

At roughly the center of the second part 35b of the connection part 34, a ring-shaped part 36 is provided that has an interior diameter of a size such that the cable can be passed therethrough. The ring-shaped part 36, at one point of the outer peripheral face thereof, is connected to the second part 35b. Due to insertion beforehand of the cable through the ring-shaped part 36, loss of the detached locking cap 1 can be prevented. A split of a width sufficiently smaller than the inner diameter of the ring-shaped part 36 may also be provided in the ring-shaped part 36. When this type of split is provided, due to insertion of the cable through the split, the locking cap 1 can be readily mounted on the cable. Furthermore, since the ring-shaped part 36 also has a certain degree of elasticity, the ring-shaped part 36 elastically returns to its original shape after insertion of the cable through the split, and falling off of the locking cap 1 from the cable can be prevented.

The locking cap 1 can be produced by known methods from an arbitrary material. For example, plastic, metal material, and the like can be used for production by injection molding and the like. Production from plastic is preferred from the standpoints of cost and mass production ability, and a thermoplastic type plastic can be used such as polypropylene, polyethylene, and the like. By use of such a relatively soft plastic, deformation of the inner face 20 to match the shape of the handling part 48 is possible during mounting of the main body 10 on the handling part 48, and engagement between the main body 10 and the handling part 48 can be further strengthened.

The applicable connector for the present invention will next be explained. The cable connector 40 is attached to a tip of the cable 50, and the cable connector 40 and the receptacle 54 are joined together at the joining face 41 thereof. The cable connector 40 has a pair of housings 42 and 42, and a plurality of core wires of the cable is separated within the housing 42. A non-illustrated interface part is provided on the front tip of the cable connector 40, and typically a plurality of contacts is disposed within the interface part. Each of the plurality of core wires of the cable is electrically connected to a respective contact among the plurality of contacts. The receptacle 54 is also provided with an interface part that has a plurality of contacts, and the interface part is normally the complement of that of the cable connector 40. The contacts of the receptacle 54 are electrically connected to a non-illustrated circuit board and the like. The cable connector 40 and the receptacle 54 are electrically mutually connected through the contacts. The cable connector 40 has a fastening screw 46 for fixing to the receptacle 54 at both side part of the cable connector 40, and locking cap 1 is mounted on each of the fastening screws 46 and 46.

A screw part 49 is provided on the front tip of the fastening screw 46, and a handling part 48 is provided on the opposite tip. A screw thread 49a is provided on the outer peripheral face of the screw part 49. The screw part 49 provided on the tip of the fastening screw 46 screws into a female screw 56 provided in the receptacle 54 such that the cable connector 40 is fixed to the receptacle 54. A plurality of grooves are provided extending in the axial direction of the fastening screw 46 on the outer peripheral face of the handling part 48 to prevent slipping of the fingers when the operator rotates the fastening screw. Moreover, in addition to grooves in the axial direction, the fastening screw 46 may have grooves extending in the circumferential direction and crossing the axial-direction grooves.

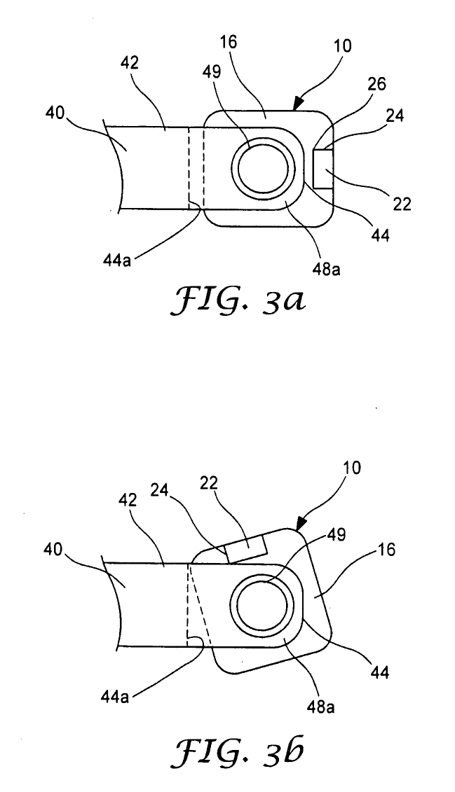

Operation of the locking cap 1 of the present embodiment will be explained while referring to FIGS. 3a and 3B. FIGS. 3a and 3b is a front view of the cable connector 40, as seen from the joining face thereof, with the locking cap 1 mounted thereon. When the cable connector 40 is engaged with the receptacle 54, these members are fastened together by the fastening screw 46. Then each main body 10 of the locking cap 1 is mounted on the respective fastening screw 46. At this time, the protrusion 22 is positioned toward the side face 44 of the cable connector 40, and a gap is opened up (FIG. 3a) between the protrusion 22 and the side face 44 such that the fastening screw 46 is able to rotate in the loosening direction thereof. When the fastening screw becomes loose due to vibration applied to the connector, the protrusion 22 contacts the housing 42 of the cable connector 40 (FIG. 3b). According to the present embodiment, the edge part 26 between the side wall 24 and the lower face 30 of the protrusion 22 contacts the cable connector 40 and operates as the contact part. Due to engagement of the locking cap 1 with the fastening screw 46 in a unified manner, when the locking cap 1 and the housing 42 touch together, further loosening of the fastening screw 46 is restricted. Furthermore, the contact part is not limited to the edge part 26, and due to shape and the like of the housing 42 of the cable connector 40, the side wall 24 of the protrusion 22 can contact the cable connector 40 such that the function of the contact part can be performed. Rotation of the fastening screw 46 also can be controlled by contact between the cable connector 40 and a part of the locking cap 1 other than the protrusion. Moreover, since position of the protrusion 22 relative to the cable connector 40 changes due to rotation of the locking cap 1, the protrusion 22 functions as an indicator part, and occurrence/non-occurrence of looseness of the fastening screw 46 can be determined by looking at the position of the protrusion 22. The fastening screw 46 and the female screw 56 are screwed together by multiple screw threads, and thus several rotations of the fastening screw 46 are normally required for the fastening screw 46 to disengage from the female screw 56. The locking cap 1 normally restricts rotation of the fastening screw 46 to less than one rotation.

Thus when looseness of the fastening screw 46 is seen using the indicator part, the fastening screw 46 screwing together with the female screw 56 is still maintained. In this manner, occurrence of looseness of the locking cap 1 can be detected prior to disengagement of the fastening screw 46 from the female screw 56. It is also possible to consider non-engaging rotation of the fastening screw 46 relative to the locking cap 1 when the force causing rotation of the fastening screw 46 due to vibration applied to the connector is unexpectedly large and such torque overcomes the engagement strength between the handling part 48 and the inner face 20. Due to the ability of the locking cap 1 to rotate relative to the cable connector 40, even in cases when the loosening of the fastening screw 46 can not be stopped, the occurrence of loosening of the fastening screw 46 can be detected based on rotation of the locking cap 1. Thus appropriate measures become possible, such as retightening of the fastening screw 46 by the operator prior to the occurrence of disengagement of the connector. Furthermore, the mounting direction of the locking cap 1 is not limited to the above mentioned direction, and any direction is permissible as long as rotation is possible in the direction of loosening of the fastening screw 46. Furthermore, although this embodiment describes a method of use that allows a certain degree of looseness of the fastening screw 46 prior to display of the loosening stoppage function by the locking cap 1, use is also possible of a locking cap 1 that does not allow any loosening of the fastening screw 46. That is to say, the locking cap 1 can be attached to the fastening screw 46 in a state that causes contact between the contact part (protrusion 22) and the cable connector 40 such that rotation of the fastening screw 46 in the loosening direction is not possible.

The indication means may be disposed by a known means on one side face 12 of the main body 10 or on the exterior face 28 of the protrusion 22 in order to further facilitate determination of the looseness of the fastening screw 46. A symbol (such as an arrow and the like), number, letter, and the like can be used as the indication means, and this indication means can be provided by a known method such as printing, transfer by engraving on a mold, and the like. When the indication means is provided in this manner, it is easy to understand which part of the locking cap 1 to refer to in order to determine the presence or absence of loosening of the fastening screw 46.

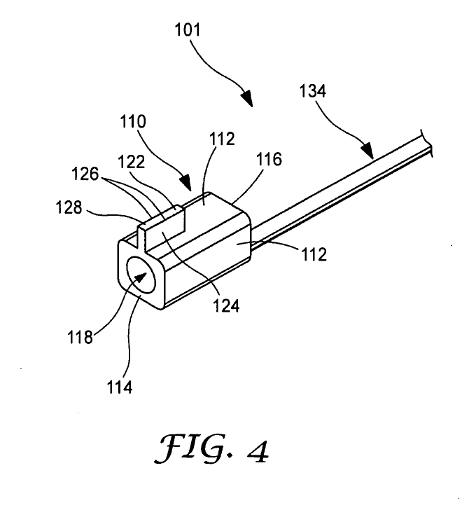

FIG. 4 shows a locking cap 101 according to a second embodiment of the present invention. The locking cap 101 is provided with a main body 110 and a connection part 134. The present embodiment differs from the first embodiment in that the protrusion 122 is placed on one side face 112 of the main body 110. Width of the protrusion 122 is narrower than width of the side face 112, and the protrusion 122 extends on one of the side faces 112 from the front end face 114 toward the rear end face 116. When the locking cap 101 is mounted on the cable connector 40 by accepting the handling part 48 in a receiving hole 118 disposed on a front end face 114, attachment is possible, for example, with the protrusion 122 oriented so as to not contact the housing 42. When loosening of the fastening screw 46 occurs due to vibration, the locking cap 101 rotates together with the fastening screw 46, and by this means, relative position of the protrusion 122 changes relative to the cable connector 40. Due to this rotation of the protrusion 122, the occurrence of loosening of the fastening screw 46 can be seen. Moreover, further rotation of the fastening screw 46 can be restricted by contact of the side wall 124 or the edge part 126 with the housing 42. In this manner, the protrusion part 122 is able to function as the contact part also for the present embodiment in which the protrusion 122 protrudes in the lateral direction. Moreover, the protrusion 122 part can function also as the indicator part in the above described manner Depending on shape or size of the cable connector, control of rotation of the fastening screw 46 is also possible by contact between the cable connector 40 and a part other than the protrusion. Furthermore, although width of the exterior face 128 is smaller than width of the side face 112 according to the structure of the present embodiment, formation is also possible such that the exterior face 128 has the same width as the side face 112. Although the protrusion 122 is disposed such that the width-direction center of the exterior face 128 roughly coincides with the width-direction center of the side face 112, a structure is also possible where these centers do not coincide. That is to say, the protrusion 122 can be disposed at a position that is displaced from the width-direction center of the side face 112. Moreover, the protrusion 122 may extend from the front end face 114 of the main body 110 to the rear end face 116. Alternatively, the protrusion 122 may extend from the rear end face 116 toward the front end face 114 over a length that is shorter than length of the main body 110. Alternatively, the protrusion 122 may extend along only a central part of the length-wise direction of the main body 110.

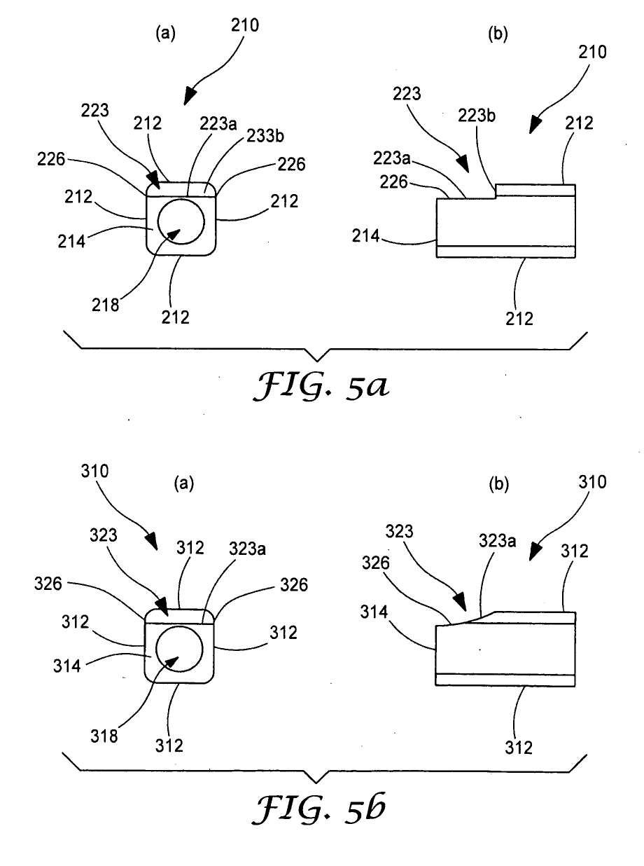

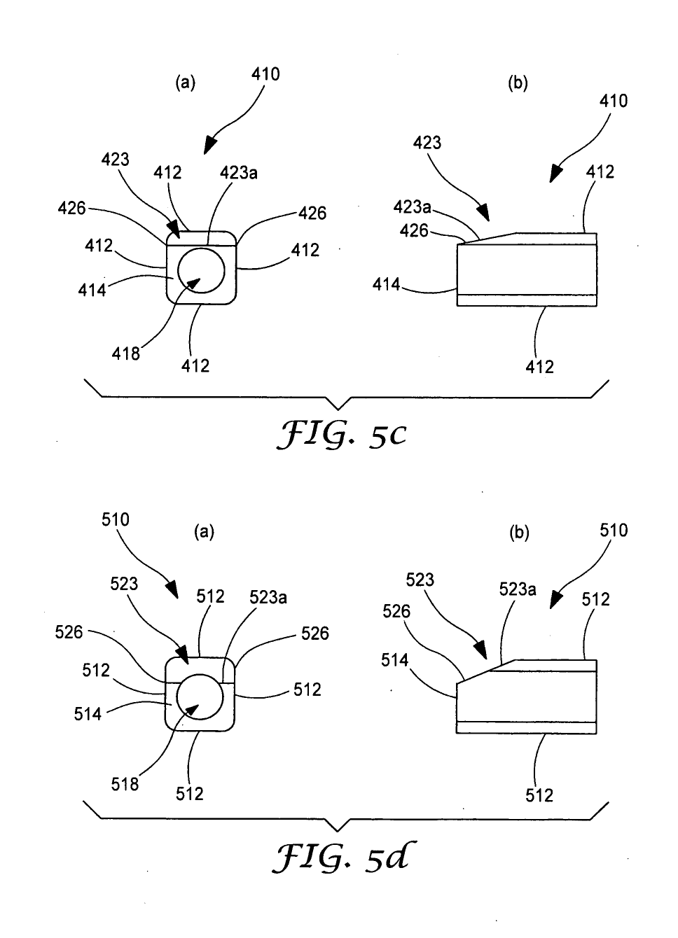

FIG. 5a shows a locking cap according to a third embodiment of the present invention. According to the present embodiment, a recess part 223 is provided in part of the main body 210. The recess part 223 has a first surface 223a that is recessed from one of the side faces 212 and has a second surface 223b that is recessed from the front end face 214. The recess part 223 surface or the edge part 226 functions as the contact part, and the recess part 223 can also function as the indicator part. An indication means can also be provided for the present embodiment, for example, by providing an indication means on the first surface 223a of one side face 212. The locking cap having this type of shape can be used in cases such as when there is a desire to suppress rotation of the locking cap using the side face 44a of the housing 42 opposite to the fastening screw 46. Meanwhile, it is possible to form the recess part 223 such that a part of the receiving hole 218 opens in the second surface 223b.

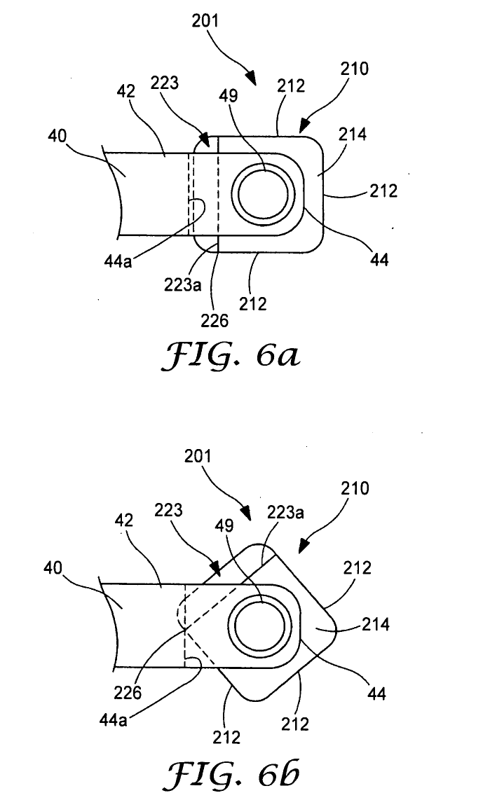

Operation of the main body 210 of the present embodiment will be explained while referring to FIGS. 6a and 6b. FIGS. 6a and 6b is a front view of the part of attachment of the fastening screw 46 of the cable connector 40 as seen from the joining face side of the cable connector 40. The first surface 223a of the recess part 223 is oriented so as to oppose the side face 44a of the cable connector 40 when the main body 210 is mounted on the handling part 48 of the fastening screw 46. At this time, the first surface 223a can be aligned roughly parallel to the side face 44a. When looseness of the fastening screw 46 occurs due to the application of vibration to the cable connector 40, the main body 210 rotates together with the fastening screw 46. When the main body 210 rotates, the edge part 226 of the recess part 223 contacts the side face 44a, and further rotation is restricted (FIG. 6b). Displacement of the recess part 223 from its initial position relative to the side face 44a can be readily seen in this state, and the operator is able to readily discover looseness of the fastening screw 46. Furthermore, orientation of the main body 210 during attachment to the fastening screw 46 is not limited to the above mentioned orientation, and any orientation is permissible as long as rotation is possible in the direction of loosening of the fastening screw 46. Moreover, using the shape of the housing 42 of the cable connector 40, the first surface 223a can function as the contact part by contacting the cable connector 40.

Variant examples of the third embodiment are presented in FIG. 5b through FIG. 5d. Within FIG. 5b, the recess part 323 is formed on a main body 310 as one bowed face 323a having a concave shape that intersects three sides faces 312 and the front end face 314. The bowed face 323a or an edge part 326 functions as the contact part, and the recess part 323 can also function as the indicator part. An indication means can also be provided for the present embodiment, for example, by providing an indication means on the bowed face 323a. It is possible to form the recess part 323 such that a part of the receiving hole 318 opens in the bowed face 323a. According to FIG. 5c, a recess part 423 is formed from a plane (tilted face) 423a that is tilted with respect to the axial direction of a main body 410 and that intersects the front end face 414 and three side faces 412. The tilted face 423a or an edge part 426 functions as the contact part, and the recess part 423 can also function as the indicator part. An indication means can also be provided for the present embodiment, for example, by providing an indication means on the tilted face 423a. It is possible to form the recess part 423 such that a part of the receiving hole 418 opens in the tilted face 423a. In FIG. 5d, a main body 510 is shown with a recess part 523 having a large size and having a receiving hole 518 as an aperture in the tilted face 523a of the recess part 523. The tilted face 523a intersects three sides faces 512 and the front end face 514. The tilted face 523a or an edge part 526 functions as the contact part, and the recess part 523 can also function as the indicator part. An indication means can also be provided for the present embodiment, for example, by providing an indication means on the tilted face 523a.

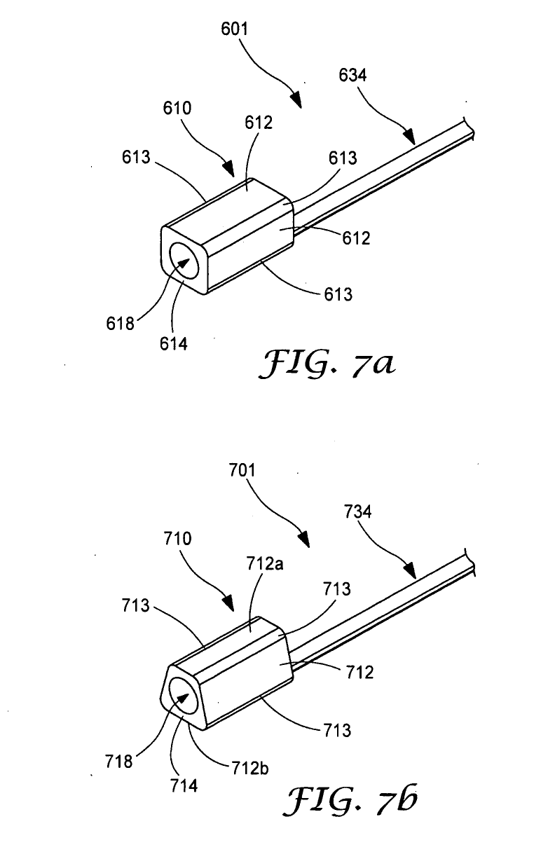

Within FIGS. 7a and 7b, a locking cap 601 is shown according to a fourth embodiment of the present invention. The locking cap 601 is provided with an approximately rectangular main body 610 and a connection part 634. The locking cap 601 differs from the above mentioned embodiments in that the main body 610 is not equipped with a protrusion or recess part. When the locking cap 601 is mounted on the cable connector by accepting the handling part 48 in a receiving hole 618 disposed on a front end face 614, the locking cap 601 can be mounted on the handling part such that one of the side faces 612 is pointed toward the cable connector. According to the present embodiment, one of the side faces 612 or a corner part 613 performs the function of the contact part, and when the fastening screw 46 becomes loose, looseness of the fastening screw 46 is prevented by contact between the cable connector 40 and the one side face 612 or the one corner part 613. One or a plurality of side faces 612 of the main body 610 is capable of functioning as the indicator part. An indicator means, such as those described previously, can be further provided on the side face 612 that functions as the indicator part.

As a variant example of the fourth embodiment, FIG. 7b, for example, shows a locking cap 701 provided with a main body 710 having a front end face 714 having trapezoidal shape and a connection part 734. According to the present variant example, when the side face 712a corresponding to the truncated side of the trapezoidal shape is disposed facing the cable connector 40 or the side face 712b corresponding to the long side of the trapezoidal shape is made to face the cable connector, the degree of permissible looseness (degree of rotation) of the fastening screw can be varied according to shape of the cable connector. When the side face 712a is made to face the cable connector 40, in comparison to the side face 712b facing the cable connector 40, the degree of permissible looseness of the fastening screw increases, and the occurrence of looseness becomes more readily visible. Moreover, rotation of the main body 710 can be readily recognized since the main body 710 has clear directionality.

The locking cap of the present invention was explained according to the above listed explanations of the embodiments. However, the present invention is not limited to the above mentioned embodiments, and further variations are possible, such as those described below. Multiple combinations of the below mentioned variations are possible, and combination with any of the above mentioned embodiments is also possible.

The receiving hole provided in the main body was described for the case of provision of a receiving hole that was co-axial with the length-direction axis of the main body. However, the receiving hole can be disposed eccentrically from the location of the length-direction axis of the main body with goals such as adjustment of the gap between the fastening screw and the housing, adjustment of the permissible degree of rotation of the fastening screw, and the like.

Any shape can be used as the shape of the main body. In addition to the roughly rectangular body shape, this shape, for example, can be a circular column shape or a polygonal column shape such as a hexagonal column and the like.

Shape of the receiving hole, in the case of use of a shape that is complementary with the shape of the handling part, can be any shape that corresponds to the shape of the handling part. Moreover, even when the shape of the receiving hole is not complementary with the shape of the handling part, any shape can be used for the receiving hole as long as relative rotation is not allowed between the handling part and the main body. For example, use of a shape is possible that contacts the handling part at part of the inner face. Furthermore, rather than a through-aperture for the receiving hole, a structure is also permissible that uses a recess having a bottom face. Although the receiving hole was a hole having a uniform diameter according to the above mentioned embodiments, a conically shaped hole, for example, is also permissible that has a large diameter at the front end face side and has a small diameter at the rear end face side. By use of this shape, mounting of the main body on the handling part is facilitated, and use becomes possible on a plurality of cable connectors having handling parts of different sizes.

What is claimed is:

1. A locking cap for a connector-fastening screw comprising:
a main body having a receiving hole,
a contact part disposed on the main body for control of rotation of the main body, and
an indicator part disposed on the main body capable of providing visual recognition of rotation of the main body.

2. The locking cap for a connector-fastening screw of claim 1, wherein
the receiving hole has an inner face capable of contacting the exterior peripheral face of the connector-fastening screw received within the receiving hole and enabling rotation of the main body and the fastening screw in a unified manner.

3. The locking cap for a connector-fastening screw of claim 1 or claim 2, wherein the contact part controls rotation of the main body by contact with the connector.

4. The locking cap for a connector-fastening screw according to any one of claims 1 through claim 3, wherein the contact part is a protrusion part protruding from the main body.

5. The locking cap for a connector-fastening screw of any one of claims 1 through claim 3, wherein the contact part is a face of a concavity of the main body.

6. The locking cap for a connector-fastening screw of any one of claims 1 through claim 3, wherein the contact part is one of a plurality of side faces of the main body.

7. The locking cap for a connector-fastening screw of any one of claims 1 through claim 6, wherein the contact part is combined with the indicator part.

8. The locking cap for a connector-fastening screw of any one of claims 1 through claim 7, wherein the locking cap further comprises an indication means on the surface of the indicator part.
